(19) United States
(12) Patent Application Publication
(10) Pub. No.: US 2004/0099814 A1
(43) Pub. Date: May 27, 2004

(54) Thermoluminescence detector and method for the production thereof

(76) Inventors: Hans-Norbert Brand, Munchen (DE); Markus Figel, Munchen (DE)

Correspondence Address: Klaus Bach, 4407 Twin Oaks Drive, Murrysville, PA, 15668, US

(21) Appl. No.: 10/719,507

(22) Filed: Nov. 21, 2003

Related U.S. Application Data
(63) Continuation-in-part of application No. PCT/EP02/04496, filed on Apr. 24, 2002.

(30) Foreign Application Priority Data
May 31, 2001 (DE) 101 26 497.6

(51) Int. Cl. G01T 1/00

(52) U.S. Cl. 250/486.1

(57) ABSTRACT

In a thermoluminescence detector, a coded cover layer is provided, which consists of a silicon resin including pigment particles, and the cover layer is pre-tempered to evaporate solvents and then coded by evaporation of areas of the layer, by means of a laser, in a selectable pattern, whereupon the coded layer is finally tempered for fixing the code pattern.

This is a Continuation-In-Part application of international application PCT/EP02/04496 filed Apr. 24, 1902 and claiming the priority of German application 101 26 497.6 filed May 31, 1901.

### BACKGROUND OF THE INVENTION

The invention relates to a thermoluminescence detector and a method for the production thereof.

DE 196 43 317 A1 discloses a finger ring dosimeter with thermo-luminescence detectors identified by inscriptions (TL detectors) as they are known from DE 196 43 316 A1. The identification number in the omni-directional DATA-MATRIX-code applied to the detectors (Φ3.9×1 mm³) must be read for an allocation of the individual calibration factor for each individual detector for determining the dose.

Up to now the detectors have been marked by expensive procedures, for example by laser imprinted heat resistant foils, which were connected to the detector crystals by means of cement. With this known method, at times, the foil extended beyond the detector surface area with the result that these detectors can be evaluated only in special measuring apparatus. The detectors marked in this way can be efficiently manufactured in large numbers only with high machinery expenses.

Other direct imprinting methods which utilize color change reactions as they are known for example from EP 0 190 997 A cannot be used because the detectors must be repeatedly heated for erasing whereby the markings are detrimentally affected or they disappear altogether.

To what degree the measuring signal is affected thereby is not known.

Methods and equipment by which large numbers of detectors can be manufactured automatically and at low costs are commercially not available.

It is therefore the object of the present invention to provide a detector and a method for a direct inscription of the detector and a method for a direct inscription of the detector which forms a heat resistant durable mark on the detector and the detector can be marked by simple means by standard laser inscription systems also in large manufacturing series.

### SUMMARY OF THE INVENTION

In a thermo-luminescence detector, a coded cover layer is provided which consists of a silicon resin including pigment particles, which layer is pre-tempered to evaporate solvents and then coded by evaporation of areas of the layer, by means of a laser, in a selectable pattern whereupon the coded layer is finally tempered for fixing the code.

Below the invention will be described in greater detail on the basis of the enclosed drawings.

### BRIEF DESCRIPTION OF THE DRAWINGS

FIG. 1 shows a structure for supporting detectors,

FIG. 2 is a top view of a detector, and

FIG. 3 is a side view of a detector.

### DESCRIPTION OF PREFERRED EMBODIMENTS

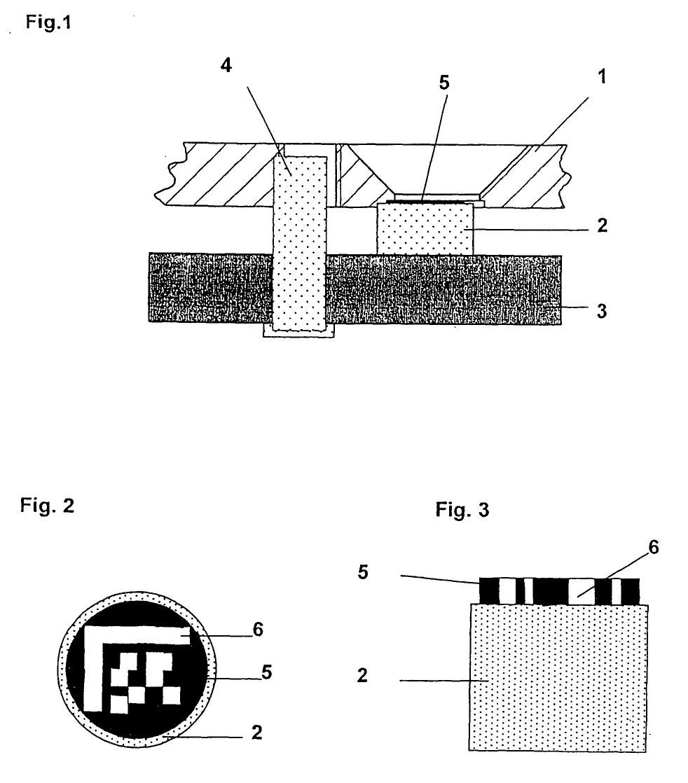

The retaining structure shown in FIG. 1 consists essentially of a cover plate 1 and a base plate 3, between which the detectors 2 are supported in a regular two-dimensional arrangement. The detectors 2 are fixed in bores with centering rings in the cover plate 1, and the two plates are interconnected by means of mounting screws 4. The centering ring is about 0.25 mm wide and about 0.25 mm high. On top of each detector 2, there is an upwardly opening funnel. By way of this funnel, the detector surface can be uniformly coated up to its rim. The material used must be able to withstand temperatures of up to 400° C., while remaining in place and keeping its shape.

The top view of FIG. 2 shows an uncoated annular area of the detector 2, which uncoated area is formed by being covered by the centering ring. The white surface areas represent the areas where the silicon resin layer 6 was burnt away. The black area represents the silicon resin layer, which has been deposited.

FIG. 3 is a side view of the detector as shown in FIG. 2 wherein the resin layer on top of the detector 2 is clearly visible.

With the method according to the invention, a surface of the TL detectors is provided with a silicon resin layer which is highly pigmented, adheres well on the crystal and has a thickness of about 30-50 μm. The pigment consists of a black iron oxide, which is highly absorbing in the infrared light range. It is present in the mixture with a weight content of 50-60%. The particle size of the pigments is about 2-4 As pigments furthermore aluminum particles, mica and talcum, zinc dust or iron mica can be used.

The pigmented silicon resin is applied by well-known paint spray procedures wherein the viscosity of the silicon resin is reduced by means of suitable solvents in order to achieve a homogeneous layer 5 of uniform thickness.

The detectors can be accommodated in a magazine-like holder, which has a capacity of about 250 detectors and which provides access only to the top surfaces of the detectors. The holder is manufactured specifically for that purpose for accommodating most working steps. The holder can be so designed that it can be used in connection with standard laser imprinting systems.

After one of the end surfaces of each detector has been spray-coated, the previously admixed solvent is evaporated to about 99% in an exhaust air annealing furnace at about 100° C. in 15 minutes. In this way, the silicon resin layer is also pre-tempered.

The detectors are marked using a standard laser imprinting system, wherein the pigmented silicon resin layer (6) is burned away in accordance with the code pattern down to the detector surface without damaging this surface. In this way, a high contrast black-white code pattern is formed.

With the use of a holder, the detectors are removed before the final tempering in order prevent them from being firmly attached to the holder and to prevent the coded surfaces from being damaged.

The final tempering of the matrix in which the pigments are dissolved occurs at a detector material-dependent temperature of between 170° C. and 400° C. over a period of about 30 min.

In this way, an optimal resistance to mechanical damage is obtained.

What is claimed is:

1. A thermoluminescence detector having a coded cover layer, said cover layer consisting of a silicon resin having pigment particles finely distributed therein, said layer having a thickness of 30 to 50 μm and having a code burnt into said cover layer by quantitative evaporation of areas of the cover layer by means of a laser in accordance with a selectable pattern.

2. A thermoluminescence detector according to claim 1, wherein said pigment particles are black iron oxide particles with a particle size of 2-4 μm.

3. A thermoluminescence detector according to claim 1, wherein the pigment content in said cover layer is between 50 and 60%.

4. A method for the manufacture of thermoluminescence detectors with a coded cover layer, comprising the following steps:
a) coating thermoluminescence crystals with a pigmented silicon including a solvent resin to form a uniform cover layer,
b) pre-tempering said cover layer at a temperature of about 100° C. for 15 min so as to evaporate to a large extent the solvent from the cover layer,
c) coding the cover layer by almost quantitative vaporization of areas of the cover layer by means of a laser in accordance with a selectable pattern, and
d) tempering the coded cover layer at a temperature of 170-400° C.

5. A method according to claim 4, wherein thermoluminescence crystals are held by a holder in an orderly two-dimensional array and are removed from said holder before final tempering.

6. A method according to claim 4, wherein said said thermo-luminescence crystals are coated with said silicon resin by a spray painting procedure.
